(19) United States
(12) Patent Application Publication
(10) Pub. No.: US 2009/0295748 A1
(43) Pub. Date: Dec. 3, 2009

(54) Touch panel display device

(75) Inventors: Xian-Jie Liu, Shenzhen (CN); Yan-Yan Sun, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/455,083

(22) Filed: May 26, 2009

(30) Foreign Application Priority Data
May 28, 2008 (CN) 200810067525.1

(51) Int. Cl. G06F 3/041

(52) U.S. Cl. 345/173

(57) ABSTRACT

A touch panel display device includes a touch panel and a frame enclosing the touch panel therein. The touch panel includes a first substrate, a second substrate opposite to the first substrate, a first conductive layer and a second conductive layer disposed on inner surfaces of the first and second substrates respectively, an enhancive layer sandwiched between the frame and the peripheral area of the first substrate, and an insulating film sandwiched between the peripheral areas of the first and second substrates. The insulating film secures the first and second substrates together, and a void is formed between the insulating film and the second conducting layer, where the enhancive layer partially overlaps the void.

### BACKGROUND

1. Technical Field

The present disclosure relates to touch panel display devices.

2. Description of Related Art

A touch panel display device generally includes a display device and a touch panel disposed on the display device. Various operations can be carried out by a user via touching appropriate parts of the touch panel with his/her finger or with a stylus.

Referring to FIG. 3, this is a schematic, side cross-sectional view of a touch panel display device 200. The touch panel display device 200 is a resistive touch panel display device, which includes a display device 20, a touch panel 22 disposed on the display device 20 and a frame 24. The display device 20 can be a liquid crystal display, a cathode-ray tube display, a plasma display panel, for example. The touch panel 22 carries out touching information by contact from a user's finger, a stylus, or another device. The frame 24 is used to enclose the display device 20 and touch panel 22 therein.

The touch panel 22 includes a first substrate 222, a second substrate 224 opposite to the first substrate 222, a first conductive layer 226, a second conductive layer 234, two electrodes 228, an insulating film 230 and a plurality of spacers 232. The first substrate 222 is far from the display device 20 compared with the second substrate 224.

The first and second conductive layers 226, 234 are respectively disposed on inner surfaces of the first and second substrates 222, 224, and are both made of transparent conductive materials, such as indium-tin oxide (ITO).

The two electrodes 228 are disposed on the inner surface of the first substrate 222 and are at opposite sides of the first conductive layer 226. The two electrodes 228 are electrically connected to the first conductive layer 226.

The spacers 232 are located between the first and second conductive layers 226, 234, spacing the first and second conductive layers 226, 234, and avoiding electrical connection therebetween unless the touch panel 22 is pressed by a finger, a stylus, or another device.

The insulating film 230 is located on peripheral areas of the first and second substrates 222, 224, to secure the first and second substrates 222, 224 together. At the same time, the insulating film 230 insulates the two electrodes 228 from the second conductive layer 234. The insulating film 230 can, for example, be made of double-sided tape or water glue.

The frame 24 includes an extending part 240 and defines a window 242. The window 242 is surrounded by the extending part 240 and is used as a display area of the touch panel display device 200. The extending part 240 is disposed on the surface of the first substrate 222 far from the second substrate 224. A reserved void L2 is formed between the insulating film 230 and the second conductive layer 234 in case the insulating film 230 such as water glue overflows into the window 242 when the first and second substrate 222, 224 are compacted together, which causes a problem of bad appearance.

The extending part 240 usually covers the reserved void L2 completely in order to avoid the problem of bad appearance. In other words, an inner edge of the extending part 240 is closer to the center of the window 242 than an inner edge of the insulating film 230 is.

However, when the frame 24 encloses the touch panel 22 and the display device 20, the touch panel 22 and the display device 20 are pressed together tightly for ensuring tightness of the touch panel display device 200. Therefore, the frame 24 will bring biggish pressure to the first substrate 222, and the extending part 240 that surpasses the insulating film 230 does not have support of the insulating film 230. Moreover, the extending part 240 contacts the peripheral area of the first substrate 222 directly, thus making the first substrate 222 located over the reserved void L2 distorted. Accordingly, the first conductive layer 226 is liable to be damaged because of the distortion of the first substrate 222. Therefore the reliability of the touch panel display device 200 relatively low.

What is needed, therefore, is a touch panel display device that can overcome the above-described deficiencies.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the described embodiments. In the drawings, like reference numerals designate corresponding parts throughout various diagrams.

FIG. 1 is a schematic top plan view of a touch panel display device of the present disclosure.

FIG. 2 is a cross-sectional view taken along line II-II of FIG. 1.

FIG. 3 is a schematic, side cross-sectional view of a conventional touch panel display device.

### DETAILED DESCRIPTION

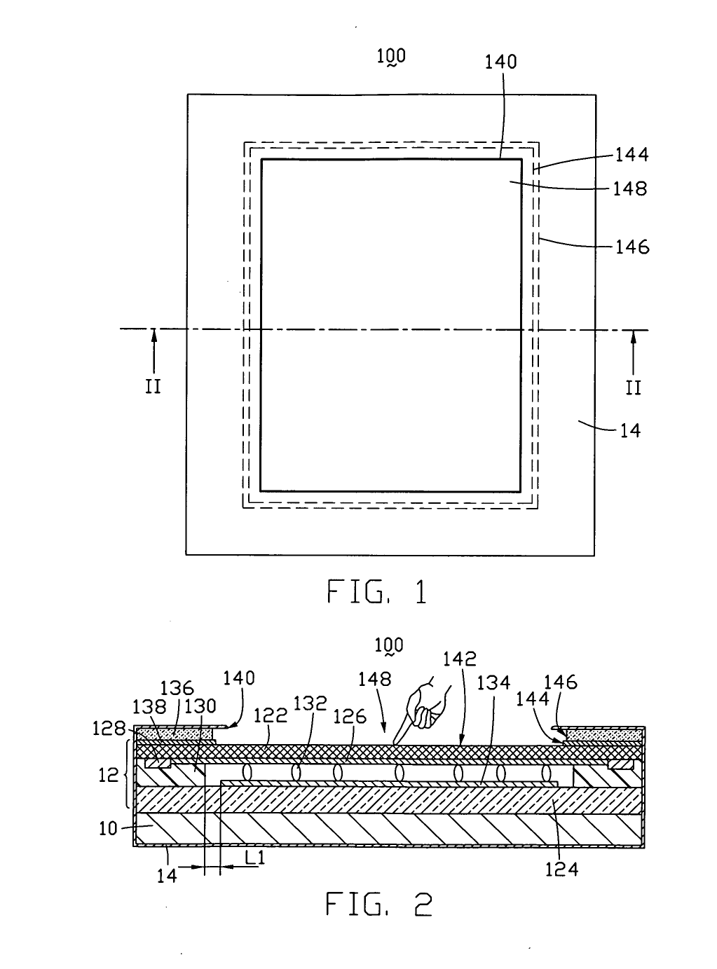

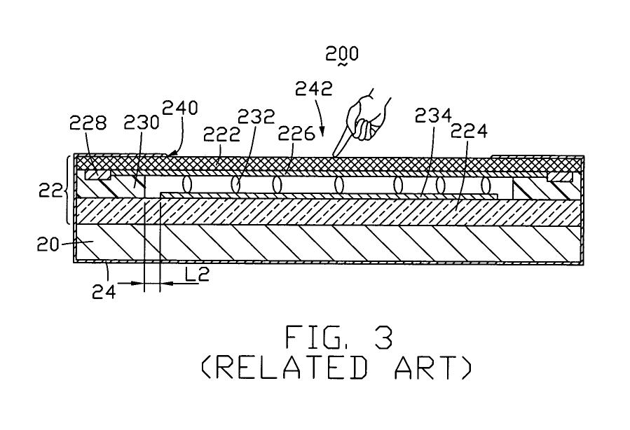

FIG. 1 is a schematic top plan view of a touch panel display device 100 of the present disclosure, and FIG. 2 is a cross-sectional view taken along line II-II of FIG. 1. In one embodiment, the touch panel display device 100 may be a resistive touch panel display device, which includes a display device 10, a touch panel 12 disposed on the display device 10, a frame 14, an anti-electrostatic layer 136 and an enhancive layer 138.

The display device 10 can be a liquid crystal display, a cathode-ray tube display, a plasma display panel, for example. The touch panel 12 carries out touching information by contact from a finger, a stylus, or another device. The frame 14 is used to enclose the display device 10 and touch panel 12 therein.

The touch panel 12 includes a first substrate 122, a second substrate 124 opposite to the first substrate 122, a first conductive layer 126, a second conductive layer 134, four electrodes 128 (only two are shown), an insulating film 130 and a plurality of spacers 132. The second substrate 124 is located between the first substrate 122 and the display device 10. A surface of the first substrate 122 that is far from the second substrate 124 defines an interface 142. The first substrate 122 can, for example, be made of soft polyethylene terephthalate (PET).

The first and second conductive layers 126, 134 are respectively disposed on inner surfaces of the first and second substrates 122, 124, and can, for example, be made of indium-tin oxide (ITO), and similar transparent conductive materials.

The two electrodes 128 are disposed on the inner surface of the first substrate 122, and are at two opposite sides of the first conductive layer 126. The electrodes 128 are electrically connected to the first conductive layer 126 respectively.

The spacers 132 are located between the first and second conductive layers 126, 134, spacing the first and second conductive layers 126, 134, and avoiding electrical connection therebetween unless the touch panel 12 is pressed by a finger, a stylus, or another device. When the interface 142 is pressed, the first substrate 122 bends towards the second substrate 124, and the touch panel 12 generates a signal as long as the first conductive layer 126 touches the second conductive layer 134. The signal will be transferred to an outer controller (not shown) so as to analyze corresponding contact-position.

The insulating film 130 is disposed on peripheral areas of the first and second substrates 122, 124, to secure the first and second substrates 122, 124 together. At the same time, the insulating film 130 insulates the two electrodes 128 from the second conductive layer 134. The insulating film 130 can, for example, be made of double-sided tape or water glue.

The frame 14 includes an extending part 140 and defines a window 148. The window 148 is surrounded by the extending part 140 and is used as a display area of the touch panel display device 100. A void L1 is formed between the insulating film 130 and the second conductive coating 134.

The anti-electrostatic layer 136 and the enhancive layer 138 are sequentially disposed between the extending part 140 and the interface 142. The anti-electrostatic layer 136 is a substantially rectangular hollow frame, which includes an inner edge 146 and an outer edge (not labeled). The anti-electrostatic layer 136 is made of an insulating anti-electrostatic foam.

The enhancive layer 138 is also a rectangular hollow frame, which includes an inner edge 144 and an outer edge (not labeled). The distance from the inner edge 144 of the enhancive layer 138 to the center of the window 148 is greater than the distance from the inner edge of the extending part 140 to the center of the window 148, but, the distance from the inner edge 144 of the enhancive layer 138 to the center of the window 148 is less than the distance from the inner edge 146 of the anti-electrostatic layer 136 to the center of the window 148. In other words, the width of the enhancive layer 138 is greater than that of the anti-electrostatic layer 136. Moreover, the enhancive layer 138 partially overlaps the void L1, and the rigidity of the enhancive layer 138 is stronger than that of both the anti-electrostatic layer 136 and the first substrate 122. The enhancive layer 138 can, for example, be made of an impact-resistance resin and is hot pressed on the peripheral area of the interface 142 of the first substrate 122 tightly.

The anti-electrostatic layer 136 is sandwiched between the enhancive layer 138 and the extending part 140 includes a top surface (not labeled) and a bottom surface (not labeled). The top surface of the anti-electrostatic layer 136 contacts the extending part 140 and the bottom surface of the anti-electrostatic layer 136 contacts the enhancive layer 138 tightly. The inner edge 146 of the anti-electrostatic layer 138 is close to the center of the window 148 in case static electricity goes into the touch panel 12 from the inner edge 144.

The rigidity of the enhancive layer 138 is greater than that of the anti-electrostatic layer 136 and the enhancive layer 138 is closer to the center of the window 148 than the anti-electrostatic layer 136 is. Because the enhancive layer 138 and the peripheral area of the first substrate 122 are pressed and combined together tightly, when the first substrate 122 receives the pressure of the extending part 140, the enhancive layer 138 does not glide easily and can absorb the pressure of the extending part 140, preventing the first conductive layer 126 from being damaged, or when the touch panel display device 100 falls off or be hit, the touch panel display device 100 endures relatively large pressure, and possesses relatively high reliability.

Because the anti-electrostatic layer 136 can, for example, be made of the insulating anti-electrostatic foam, which not only can absorb the pressure brought to the touch panel 12 by the extending part 140, but can also prevent static electricity from influencing the touch panel 12. Therefore, the touch panel display device 100 has higher reliability.

In other embodiments, the anti-electrostatic layer 136 and the enhancive layer 138 overlap the void L1 substantially completely. In other words, the distances from the inner edge 146 of the anti-electrostatic layer 136 to the center of the window 148 and from the inner edge 144 of enhancive layer 144 to the center of the window 148 are both less than the distance from the insulating film 130 to the center of the window 148.

It is to be understood, however, that even though numerous characteristics and advantages of the present embodiments have been set out in the foregoing description, together with details of the structures and functions of the embodiments, the invention is illustrative only; and that changes may be made in detail, especially in matters of arrangement of parts within the principles of the invention to the full extent indicated by the broad general meaning of the terms in which the appended claims are expressed.

What is claimed is:

1. A touch panel display device, comprising a touch panel and a frame enclosing the touch panel therein, the touch panel comprising:
a first substrate;
a second substrate opposite to the first substrate;
a first conductive layer and a second conductive layer disposed on inner surfaces of the first and second substrates, respectively;
an insulating film sandwiched between peripheral areas of the first and second substrates, to secure the first and second substrates together, and a void between the insulating film and the second conducting layer; and
an enhancive layer sandwiched between the frame and the peripheral area of the first substrate, the enhancive layer partially overlapping the void.

2. The touch panel display device of claim 1, wherein the enhancive layer overlaps the void substantially completely.

3. The touch panel display device of claim 1, wherein the enhancive layer is a rectangular hollow frame, the first substrate comprises an interface, and the enhancive layer is hot pressed on the peripheral area of the interface.

4. The touch panel display device of claim 3, further comprising an anti-electrostatic layer, wherein the anti-electrostatic layer is a substantially rectangular hollow frame.

5. The touch panel display device of claim 4, the enhancive layer comprising an inner edge, the frame comprising an extending part and defining a window, wherein the window is surrounded by the extending part, the distance from inner edge of the extending part to a center of the window is less than the distance from the inner edge of the enhancive layer to the center of the window.

6. The touch panel display device of claim 5, wherein the window is used as a display area of the touch panel display device.

7. The touch panel display device of claim 5, wherein the anti-electrostatic layer is sandwiched between the extending part and the enhancive layer.

8. The touch panel display device of claim 7, wherein the anti-electrostatic layer comprises an inner edge, and the distance from the inner edge of the enhancive layer to the center of the window is less than the distance from the inner edge of the anti-electrostatic layer to the center of the window.

9. The touch panel display device of claim 8, wherein the rigidity of the enhancive layer is greater than the rigidity of the anti-electrostatic layer.

10. The touch panel display device of claim 9, wherein the enhancive layer is made of impact-resistance resin, and the anti-electrostatic layer is made of an insulating anti-electrostatic foam.

11. The touch panel display device of claim 9, further comprising a display device on which the touch panel is disposed.

12. A touch panel display device, comprising a touch panel and a frame enclosing the touch panel therein, the touch panel comprising an interface, wherein the touch panel display device further comprises an enhancive layer disposed between the peripheral area of the interface and the frame.

13. The touch panel display device of claim 12, wherein the touch panel further comprises a first substrate and a second substrate opposite to the first substrate, the rigidity of the enhancive layer is greater than the rigidity of the first substrate.

14. The touch panel display device of claim 12, further comprising an anti-electrostatic layer, the rigidity of the enhancive layer is greater than the rididity of the anti-electrostatic layer.

15. The touch panel display device of claim 14, the enhancive layer comprising an inner edge, the frame comprising an extending part and defining a window, wherein the window is surrounded by the extending part, the distance from inner edge of the extending part to a center of the window is less than the distance from inner edge of the enhancive layer to the center of the window.

16. The touch panel display device of claim 15, wherein the anti-electrostatic layer is sandwiched between the enhancive layer and the extending part.

17. The touch panel display device of claim 14, wherein the enhancive layer is made of impact-resistance resin, and the anti-electrostatic layer is made of an insulating anti-electrostatic foam.

18. The touch panel display device of claim 16, wherein the anti-electrostatic layer includes an inner edge, the distance from the inner edge of the enhancive layer to the center of the window is less than the distance from the inner edge of the anti-electrostatic layer to the center of the window.
